(19) United States
(12) Patent Application Publication
(10) Pub. No.: US 2012/0254722 A1
(43) Pub. Date: Oct. 4, 2012

(54) INTERACTIVE USER INTERFACE IMPLEMENTATION AND DEVELOPMENT ENVIRONMENT THEREFOR

(75) Inventors: Aaron Newton, San Francisco, CA (US); Philip Zeyliger, San Francisco, CA (US)

(73) Assignee: Cloudera, Inc., Palo Alto, CA (US)

(21) Appl. No.: 13/077,878

(22) Filed: Mar. 31, 2011

(51) Int. Cl. G06F 17/00

(52) U.S. Cl. 715/234

(57) ABSTRACT

Systems and methods of interactive user interface implementation and development environment therefor are disclosed. One embodiment of implementing interactive elements in a web page on a client device includes, sending, by the client device, a request to a web server in response to an event triggered in a frame of the web page having multiple frames, processing a web server response from the web server for the frame, and/or unloading contents of the frame, after receipt of the web server response, independent of the other frames in the web page when in accordance with rules defined for the web server response.

### BACKGROUND

Emphasis and focus on front-end, or user interface (UI) development of software development has gained significant traction and is a major factor determining in time-to-deployment. In particular JavaScript is now used extensively in developing interactive features for web pages. However, significant reliance on JavaScript for interactive UI implementation can delay the software development process due to insufficient proficiency of the labor force in JavaScript programming.

### BRIEF DESCRIPTION OF THE DRAWINGS

FIG. 1 illustrates a block diagram of a server for hosting user interface applications able to communicate with a client device web browser and a computing environment through a network. An exploded view of an example of a server configuration is also illustrated.

FIG. 2 depicts an architectural view of a user interface application managed by a user interface module which can span a browser tier, a host server, and/or a backend.

FIG. 3 depicts a block diagram illustrating example components of an interactive UI module and a UI development module.

FIG. 4A depicts a graphical diagram of multiple applications running inside individual frames on a web page.

FIG. 4B depicts an example of a windowing environment having a user interface with two frames, each capable of handling its own server request and response.

FIG. 5 graphically depicts an example of how interactive UI behaviors can be modularized in software code as re-usable widgets to implement interactive UI features without using JavaScript.

FIG. 6 depicts a block diagram illustrating an example of events that occur in creating interactive states in a user interface.

FIG. 7 depicts a flowchart of an example process for implementing interactive elements in a web page.

FIG. 8 depicts a flowchart of an example process for enabling development of a user interface without reliance on JavaScript.

FIG. 9 shows a diagrammatic representation of a machine in the example form of a computer system within which a set of instructions, for causing the machine to perform any one or more of the methodologies discussed herein, may be executed.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative-embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Embodiments of the present disclosure include systems and methods for interactive user interface implementation and development environment therefor.

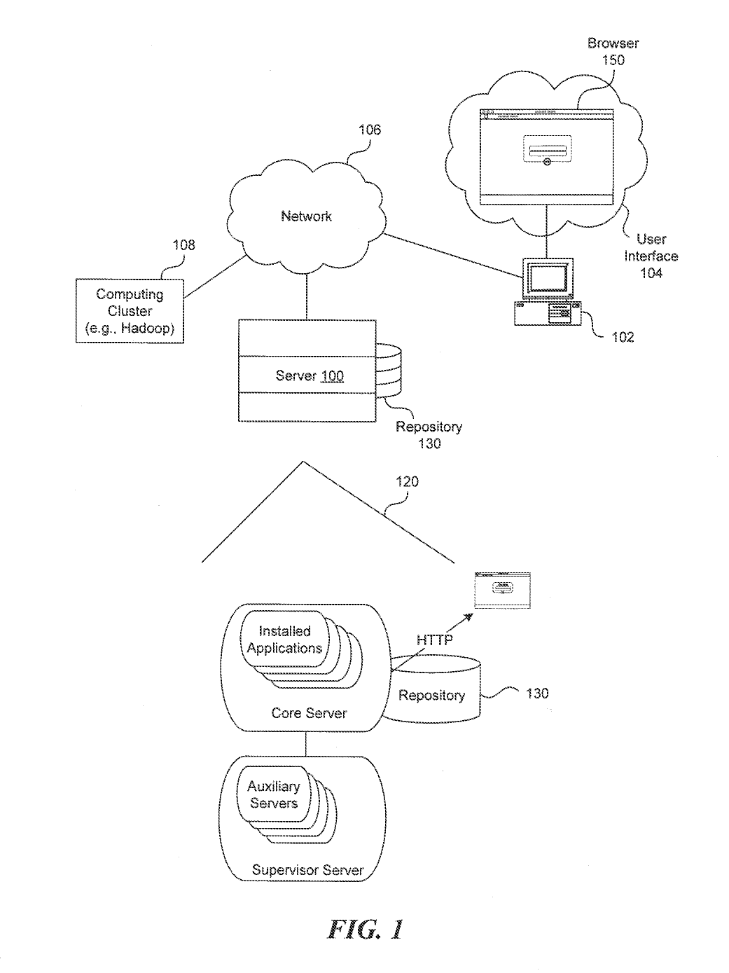

FIG. 1 illustrates a block diagram of a server 100 for hosting user interface applications able to communicate with a client device 102 web browser 150 and a computing environment 108 through a network 106. An exploded view 120 of an example of a server configuration is also illustrated.

The client device 102 can be any system and/or device, and/or any combination of devices/systems that is able to establish a connection with another device, a server and/or other systems. The client device 102 typically includes a display or other output functionalities to present data exchanged between the devices to a user, for example through a user interface 104. The user interface 104 can be used to access a web page via browser 150. The web page can include frames containing applications which can handle its own server requests, independent of the other frames in the web page. The browser 150 can be used by users and/or developers to access a UI development environment hosted by the server 100. In one embodiment, the UI development environment enables developers to build interactive UI features in an application by specifying mark-up tags in HTML. The application may be used to access any backend services and can include a Hadoop enabled backend system.

The client device 102 can be, but are not limited to, a server desktop, a desktop computer, a thin-client device, an internet kiosk, a computer cluster, a mobile computing device such as a notebook, a laptop computer, a handheld computer, a mobile phone, a smart phone, a PDA, a Blackberry device, a Treo, and/or an iPhone, etc. In one embodiment, the client device 102 is coupled to a network 106.

In one embodiment, users or developers interact with the client device 102 (e.g., machines or devices) to access the server 100 and services provided therein. Specifically, users or software developers can develop applications and/or application front-ends (e.g., user interfaces) for accessing the computing cluster by interacting with the server 100 via the client device 102. The server 100 hosts applications with interactive user interfaces and a development environment used for such purpose. The development environment allows developers to create HTML applications with interactive features without significant use of CSS or JavaScript thus significantly reducing time and resource to deployment.

In one embodiment, end users can interact with the computing cluster 108 (e.g., machines or devices). As a results of the user interaction, the cluster 108 can generate datasets such as log files to be collected and aggregated. The file can include logs, information, and other metadata about clicks, feeds, status updates, data from applications, and associated properties and attributes. The computer cluster 108 can be managed under the Hadoop framework (e.g., via the Hadoop distributed file system or other file systems which may be distributed file systems, non-distributed file systems, distributed fault-tolerant file systems, parallel file systems, peer-to-peer file systems, including but not limited to, CFS, Unilium, OASIS, WebDFS, CloudStore, Cosmos, dCache, Parallel Virtual File System, Starfish, DFS, NFS, VMFS, OCFS, CXFS, DataPlow SAN File System, etc.). Such log files and analytics can be accessed or manipulated through applications hosted by the server 100. Interactive user interfaces for applications hosted on the server 100 can be used to access backend services hosted in the cluster 108, for example.

In one embodiment, the server 100 includes user interface modules to implement interactive elements in a windowing environment (e.g., a web page in a browser) and user interface development modules for developer use in developing interactive UI features using declarative HTML (e.g., without the need for significant use of JavaScript). The server 100 can include multiple devices including a core server which hosts installed applications and auxiliary servers which manage auxiliary processes, Which may be ran by applications on the core server. In some instances, the auxiliary servers are coupled to a supervisor server which initiates the processes in the auxiliary servers.

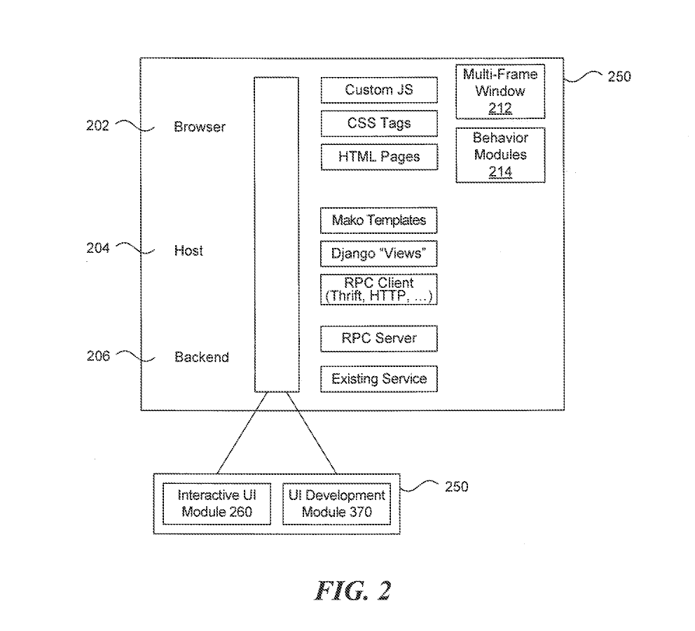

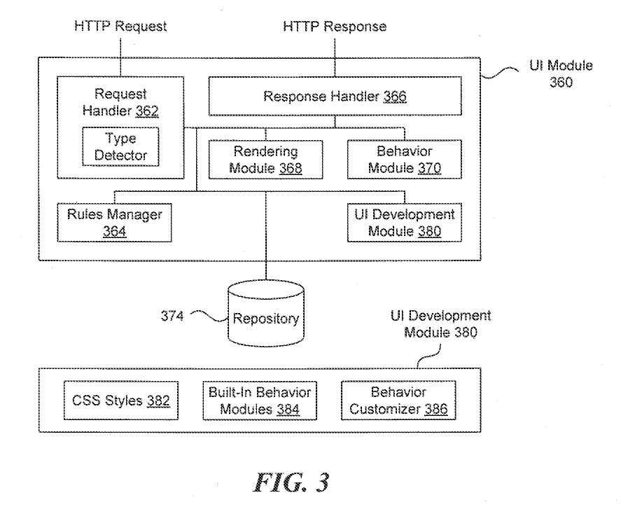

The functionalities and features of the UI modules and UI development modules are described with further reference to the examples of FIG. 2-3.

The network 106, over which the client device 102, server 100, and cluster 208 communicate may be a telephonic network, an open network, such as the Internet, or a private network, such as an intranet and/or the extranet. For example, the Internet can provide file transfer, remote log in, email, news, RSS, and other services through any known or convenient protocol, such as, but is not limited to the TCP/IP protocol, Open System Interconnections (OSI), FTP, UPnP, iSCSI, NSF, ISDN, PDH, RS-232, SDH, SONET, etc.

The network 106 can be any collection of distinct networks operating wholly or partially in conjunction to provide connectivity to the client devices, host server, and may appear as one or more networks to the serviced systems and devices. In one embodiment, communications to and from the client device 102 can be achieved by an open network, such as the Internet, or a private network, such as an intranet and/or the extranet. In one embodiment, communications can be achieved by a secure communications protocol, such as secure sockets layer (SSL), or transport layer security (TLS).

The term “Internet” as used herein refers to a network of networks that uses certain protocols, such as the TCP/IP protocol, and possibly other protocols such as the hypertext transfer protocol (HTTP) for hypertext markup language (HTML) documents that make up the World Wide Web (the web). Content is often provided by content servers, which are referred to as being “on” the Internet. A web server, which is one type of content server, is typically at least one computer system which operates as a server computer system and is configured to operate with the protocols of the World Wide Web and is coupled to the Internet. The physical connections of the Internet and the protocols and communication procedures of the Internet and the web are well known to those of skill in the relevant art. For illustrative purposes, it is assumed the network 106 broadly includes anything from a minimalist coupling of the components illustrated in the example of FIG. 1, to every component of the Internet and networks coupled to the Internet.

In addition, communications can be achieved via one or more wireless networks, such as, but is not limited to, one or more of a Local Area. Network (LAN), Wireless Local Area Network (WLAN), a Personal area network (PAN), a Campus area network (CAN), a Metropolitan area network (MAN), a Wide area network (WAN), a Wireless wide area network (WWAN), Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G, 4G, LTE networks, enhanced data rates for GSM evolution (EDGE), General packet radio service (GPRS), enhanced GPRS, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols.

The client device 102 can be coupled to the network (e.g., Internet) via a dial up connection, a digital subscriber loop (DSL, ADSL), cable modem, and/or other types of connection. Thus, the client device 102 can communicate with remote servers (e.g., web server, host server, mail server, and instant messaging server) that provide access to user interfaces of the World Wide Web via a web browser, for example.

The repository 130, though illustrated to be coupled to the server 100, can also be coupled to the computing cluster 108, either directly or via network 106. In one embodiment, the repository 130 can store session data from web URL retrieval and view generation processes to facilitate the host 100 in generating interactive user interface features. For example, the repository 130 can store session information and session states (e.g., session complete, session in progress, etc.). In addition, the repository 130 can optionally be used to store job designs for use in front end development.

The repository 130 can additionally store software, descriptive data, images, system information, drivers, collected datasets, aggregated datasets, log files, analytics of collected datasets, enriched datasets, etc. The repository may be managed by a database management system (DBMS), for example but not limited to, Oracle, DB2, Microsoft Access, Microsoft SQL Server, MySQL, FileMaker, etc.

The repository can be implemented via object-oriented technology and/or via text files, and can be managed by a distributed database management system, an object-oriented database management system (OODBMS) (e.g., ConceptBase, FastDB Main Memory Database Management System, JDOInstruments, ObjectDB, etc.), an object-relational database management system (ORDBMS) (e.g., Informix, OpenLink Virtuoso, VMDS, etc.), a file system, and/or any other convenient or known database management package.

FIG. 2 depicts an architectural view of a user interface application managed by a user interface module 250 which can span a browser tier 202, a host tier 204, and/or a backend 206.

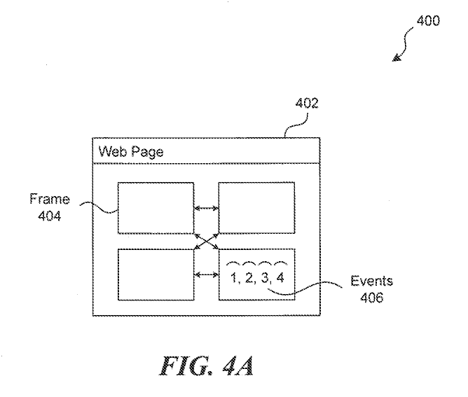

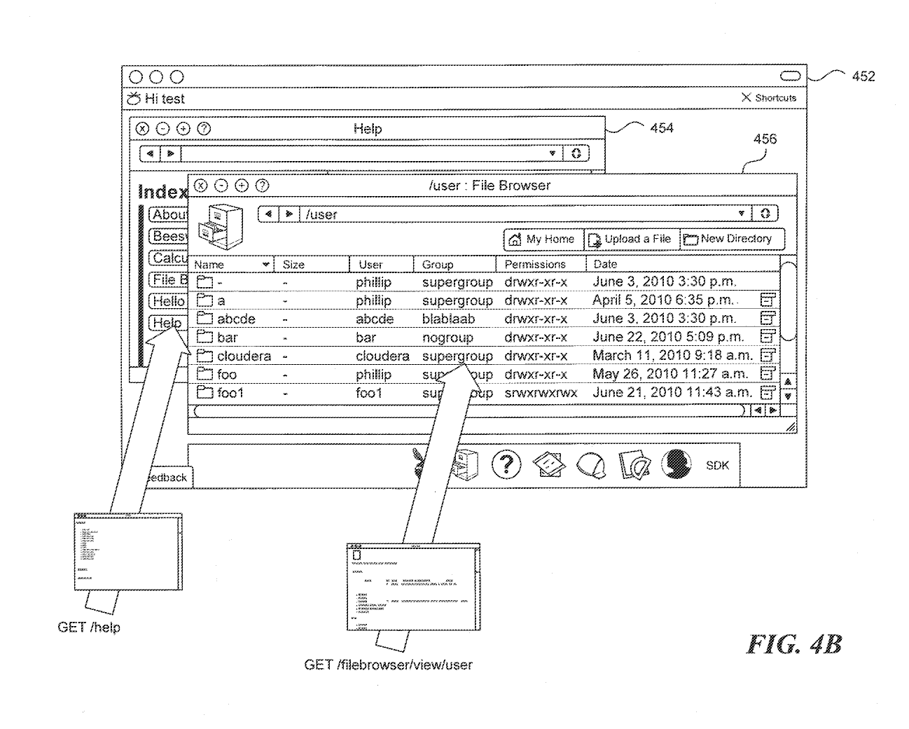

The browser tier 202 includes the user interface and the user's interaction with web pages (e.g., HTML web pages) and applications in a windowing environment such as a web browser. In one embodiment, the browser tier 202 includes a multi-framed window 212 (e.g., multiple frames in a web page) which depicts individual applications that are able to handle their own HTTP request. For example, the multi-framed window 212 can include a web-browser with multiple frames with applications that handle HTTP requests independent of other frames. The responses received from the requests can also be rendered in each of the multiple frames individually in the same web page independent of the rendering process in the other frames. A graphical example of a multi-frame window 212 is illustrated in the example of FIG. 4A-4B.

One embodiment of the browser tier 202 further includes behavior module 214 which, during operation, handles the interactive behaviors implemented for user interface elements defined using declarative HTML. The interactive behaviors can be defined as software modules (e.g., in the UI development module 270) for use in development of an application's front end. The UI behaviors can be executed by the behavior module 214 by replacing mark-up tags with the corresponding software modules, for example, at the browser level. The server can send back HTML with some tags; the browser finds those tags and executes code corresponding to those tags.

The host tier 204 includes logic to host the applications and can provide default or predefined templates of any templating-technology (e.g., Mako, JSP, django templates, velocity templates) and views (e.g., Django views) for use in UI/front end development. An application front end developed by a user using the UI module 205 can include a view function (e.g., a Django view function) which processes an HTTP request and the associated template to render the server response into HTML. Note that while the application front-end (user interface) can be developed using the UI module 250 without significant reliance on Javascript can still include some custom JavaScript and CSS styles.

The backend tier 206 can include backend services such as external services (e.g., Hive metastore, Hadoop MapReduce) with which the applications hosted on tier 204 may interact. For example, the backend can include a RPC (remote procedure call) server (e.g., Hive server) which interacts with an RPC client in the host tier 204.

FIG. 3 depicts a block diagram illustrating example components of an UI module 360 and a UI development module 380.

In one embodiment, the UI development module 380 is implemented in the US module 360, as illustrated in the example of FIG. 3. Alternatively, the UI development module 380 may be partially or wholly external to the UI module 360 but coupled directly or through a network. The interactive UI module 360, can additionally include, a request handler 362, a rules manager 364, a response handler 366, a rendering module 368, a behavior module 379. The interactive UI module 360 may be further coupled a repository 374 and backend services 376. The UI development modules 380 can include a repository of CSS styles 382, behavior modules 384, and/or a behavior customizer 386. The repository of CSS styles 382 can include a collection of default style sheets with user interface components to be provided to developers to create applications in a development environment. Developers can also define their own CSS styles. Additional or less modules can be included the modules 360 and 380.

As used in this paper, a “module,” a “manager”, a “handler”, or an “engine” includes a dedicated or shared processor and, typically, firmware or software modules that are executed by the processor. Depending upon implementation-specific or other considerations, the module, manager, hander, or engine can be centralized or its functionality distributed. The module, manager, hander, or engine can include special purpose hardware, firmware, or software embodied in a computer-readable medium for execution by the processor. As used in this paper, a computer-readable medium or computer-readable storage medium is intended to include all mediums that are statutory (e.g., in the United States, under 35 U.S.C. 101), and to specifically exclude all mediums that are non-statutory in nature to the extent that the exclusion is necessary for a claim that includes the computer-readable (storage) medium to be valid. Known statutory computer-readable mediums include hardware (e.g., registers, random access memory (RAM), non-volatile (NV) storage, to name a few), but may or may not be limited to hardware.

One embodiment of the UI module 360 includes a request handler 362. The request handler 362 can be implemented, example, as software embodied in a computer-readable medium or computer-readable storage medium on a machine, in firmware, in hardware, in a combination thereof, or in any applicable known or convenient device or system. This and other modules or engines described in this specification are intended to include any machine, manufacture, or composition of matter capable of carrying out at least some of the functionality described implicitly, explicitly, or inherently in this specification, and/or carrying out equivalent functionality.

The request handler 362, in one embodiment, receives, manages, processes, intercepts, requests received as a response of an event occurring at a windowing environment. The windowing environment includes a user interface level environment through which a user interacts to manipulate or access applications. The windowing environment can include a browser (e.g., directory browser or web browser, etc.) through which user action triggers events which generates requests. In one embodiment, the request includes an HTTP request generated as a result of user action on a web page.

The event can be triggered in a frame of the web page, which can include multiple frames. The event can include, by way of example but not limitation, a form submit, a link click, or any other custom calls. One embodiment of the request handler 362 includes a type detector, which can identify the type of event which generated a request. The request type can be used by the rules manager 364 to apply any type-specific processing or rendering procedures.

In one embodiment, the request handler 362 sends the request from the client device where the request was generated to a recipient device (e.g., a web server). The request handler 362 can process and send requests (e.g., HTTP requests or XML HTTP requests) independently for events triggered in each of the multiple frames in a single browser, a single web page, or other windowing environment. For example, each of the multiple frames of the web page can include different applications which handle corresponding requests to the web server independent of the other applications loaded in other frames. Examples of a multi-frame windowing environment are illustrated graphically in FIG. 4A-4B.

One embodiment of the UI module 360 includes a rules manager 364. The rules manager 364 can be implemented, example, as software embodied in a computer-readable medium or computer-readable storage medium on a machine, in firmware, in hardware, in a combination thereof, or in any applicable known or convenient device or system. This and other modules or engines described in this specification are intended to include any machine, manufacture, or composition of matter capable of carrying out at least some of the functionality described implicitly, explicitly, or inherently in this specification, and/or carrying out equivalent functionality.

The rules manager 364 can determine and/or apply the rules to processing an HTTP server request and/or response. For example, the rules manager 364 can, in response to determining that a triggering event is a link selection, that custom actions, if applicable, could be applied. Examples of custom actions can include actions defined for a date picker element on a user interface which specifies that when a link for a date picker (element ‘x’) is clicked, focus instead on another element (element ‘y’). Additional custom actions can include, by way of example, but not limitation (1) Convert a table into a graphical representation (e.g., pie graph or line graph), (2) refresh the page, (3) load a new dataset lazily, (4) trigger a notification “bubble”, (5) show a right-click/context menu, (6) enable a tool tip, (7) prompt, upon click, with a confirmation pop-up, (8) toggle the visibility of other page elements, (9) toggle a slide-out drawer. Such a custom action can then be created as a behavior (e.g., by the behavior customizer module 386) for a date picker element, or other elements, can be created as a software module (e.g., widget) for reuse in implementing other date pickers, or other elements with a similar behavior.

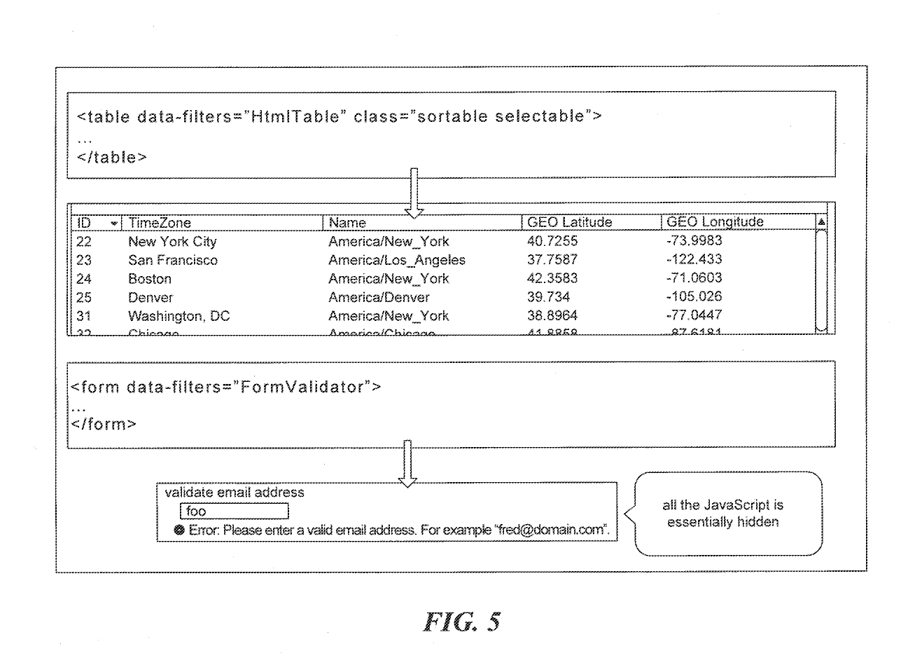

Such custom action essentially corresponds to the behavior (e.g., including various forms of interactive features and behaviors) of a user interface element, such as a button, or link, etc. The custom actions can be predefined and provided to a developer and/or defined by a developer and reused in another application or by another developer. The custom action can be created as a re-usable module (e.g., for example, by the behavior customizer 386 of the UI development module 380) and provided as a software module by the behavior module 384 for others to use. FIG. 5 graphically depicts an example of how interactive UI behaviors can be modularized in software code as re-usable widgets to implement interactive UI features without using JavaScript.

Built-in actions can also be defined through the built-in behavior modules 384 in the UI development module 380. Some examples of built in behavior modules include, form validation, customizable right-click context menus, sortable tables, tabbed interface elements, tool tips, date selector for input forms, etc. When content or a web page is loaded in response to receiving a server response, the behavior module 370 and load/render the content based on the custom action defined in the widget.

One embodiment of the UI module 360 includes a response handler 366 and a rendering module 368. The response handler 366 and the rendering module 368, can each be implemented, for example, as software embodied in a computer-readable medium or computer-readable storage medium on a machine, in firmware, in hardware, in a combination thereof, or in any applicable known or convenient device or system. This and other modules or engines described in this specification are intended to include any machine, manufacture, or composition of matter capable of carrying out at least some of the functionality described implicitly, explicitly, or inherently in this specification, and/or carrying out equivalent functionality.

In one embodiment, the response handler 366 receives processes, retrieves, parses, and/or identifies a response received responsive to the request generated in a windowing environment. For example, the response handler 366 can process a web server response received from a web server in response to an HTTP request sent in response to an action triggered in a frame or a web page, browser, or other windowing environments.

In one embodiment, the response handler 366 can process the response in accordance with the rules set forth for the web server response (e.g., as provided by the rules manager 364) and rendered by the rendering module 368. In general, the response (e.g. HTTP response) received in response to the triggering event occurring in a frame, is handled independently of responses received for other frames in a common web page, browser, or windowing environment. The state of the frame for which a response is received is updated and maintained by the response handler 366 independently of the activity of other frames. States of frames in a windowing environment can be stored and maintained in the repository 374 and accessed and updated accordingly when states are updated upon receiving a server response. For example, the response handler 366 can update the states maintained or stored for various frames in a windowing environment (e.g., a web page or browser).

In one embodiment, the response handler 366 receives the response and the rendering module 368 processes the response for rendering in the user interface. In one embodiment, the rendering module 368 also allows custom rules for rendering to be defined. The custom rules specify how to handle responses received from a web server. By default, the rendering module 368 implements the following responses: an alert response, a confirm response, and a default response. The default response is performed when no interruption occurs based on the server response and proceeds with unloading and loading of new content. The alert response triggers a modal dialog box indicating an error to the user and returning him to the previous state. The confirm response, confirms with the user whether the requested action is to be performed.

The rendering module 368 renders the display on a frame by frame basis, independent of the other frames in the same windowing environment, browser, or web page. For example, the rendering module 368 can unload the contents of each frame independent of the other frames on a web page. In general, the rendering module 368 renders the results of the web server response in the frame of the web page in which the event was triggered, independent of the other frames.

FIG. 4A depicts a graphical diagram 400 of multiple applications running inside individual frames 404 on a web page 402.

In general, the requests received in each frame can be handled on a frame-by-frame basis, independent of the other frames in the same windowing environment (e.g., a web page, web browser, or a general browser). For example, when a link is clicked, a series of events 406 occurs in the frame in which the click occurred. The link can be loaded in the same frame in which it was selected, independent of the other frames on the web page and that each of the multiple frames performs its own load and unload operations, independent of the other frames.

While the frames 404 perform independent actions and can maintain, store, and update their individual states, the frames are typically capable of interacting with one another and are aware of the presence of other frames in the same windowing environment. In some instances, the frames and the applications loaded in the frames are capable of sharing common resources and as such, shared resource among any of the multiple frames can be loaded once and used among the applications in the same windowing environment (e.g., browser or web page). FIG. 4B depicts another example of a windowing environment 452 having a user interface with two frames 454 and 456, each capable of handling its own server request and response, while being aware of each others' presence and are able to communicate with one another for resource sharing and other actions.

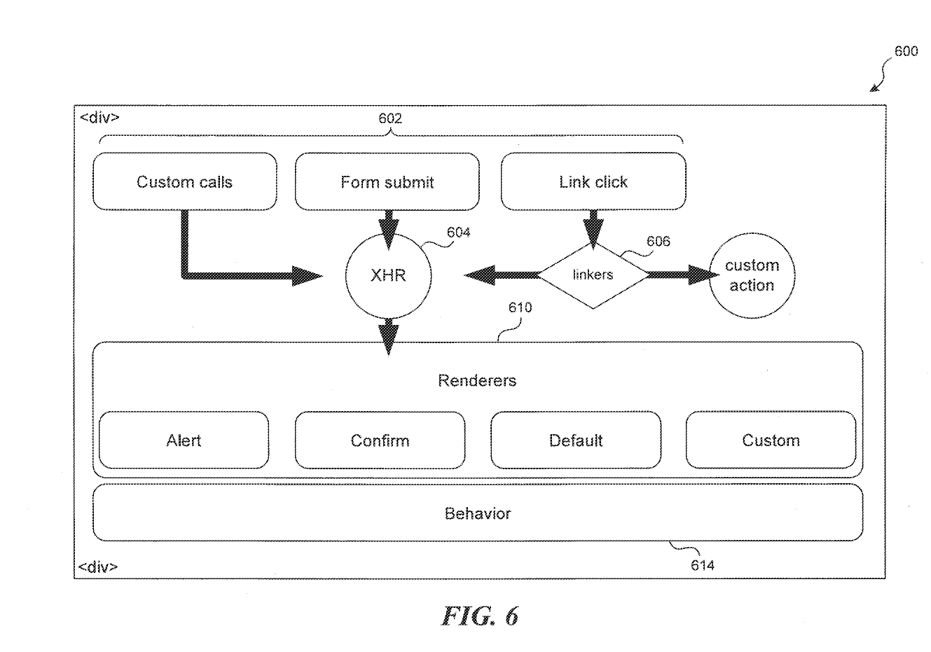

FIG. 6 depicts a flow diagram illustrating an example of events that occur in creating and rendering interactive states on a web page through XML HTTP (XHR) requests.

The events can occur through interaction with an application depicted on a web page to access any type of backend services. In one embodiment the application is used to interact or manipulate a distributed file system (e.g., a Hadoop distributed file system).

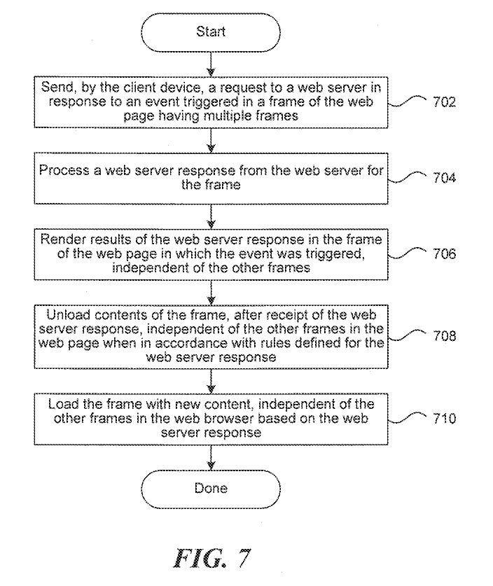

FIG. 7 depicts a flowchart of an example process for implementing interactive elements in a web page.

In process 702, the client device can send a request to a web server in response to an event triggered in a frame of the web page having multiple frames. The request can include an HTTP request or XML HTTP request (XHR). In one embodiment, each of the multiple frames of the web page includes different applications which handle corresponding requests to the web server independent of the other applications loaded in other frames in the web page.

In general, each of the multiple frames maintains its own state independent of the other frames. In addition, each of the multiple frames performs its own load and unload operations, independent of the other frames. However, each frame is aware of the existence and activity of the other frames and can share any common resources. For example, shared resource among any of the multiple frames can be loaded once on the web page, and rendered in multiple frames. In one embodiment, garbage collection is implemented in the frames to manage the memory use of the browser.

The event triggering the request can include, for example, a form click, a link selection, or any custom calls. In one embodiment, when the triggering event is a link selection by a user, custom actions can be performed. In general, as a result, the link is loaded in the frame in which the link was selected, independent of the other frames on the same web page or windowing environment.

In process 704, a web server response from the web server for the frame is processed, for example, in accordance with rules defined for the web server response. The rules can include, by way of example, one or more of, an alert response, a confirm response, and a default response. In general, the rules are modifiable and/or user-customizable. New rules may also be defined.

In process 706, results of the web server response are rendered in the frame of the web page in which the event was triggered, independent of the other frames. In process 708, contents of the frame are unloaded after receipt of the web server response, independent of the other frames in the web page when in accordance with rules defined for the web server response. In process 710, the frame is loaded with new content, independent of the other frames in the web browser based on the web server response. In addition, the frame allows navigation independent of the other frames in the web page, for example, the frame can allow navigating forward or backwards to a previous or early webpage in the frame. Such navigation can be achieved independently, without affecting the state of other frames in the web page (e.g., causing other frames to load, or unload, or also navigating forward/backwards).

The contents of the frame can include interactive web page features that are defined using HTML mark-ups. The contents of the frame may also include interactive web page features that are defined without using javaScript. In one embodiment, the web page interacts with a distributed file system (e.g., the Hadoop distributed file system).

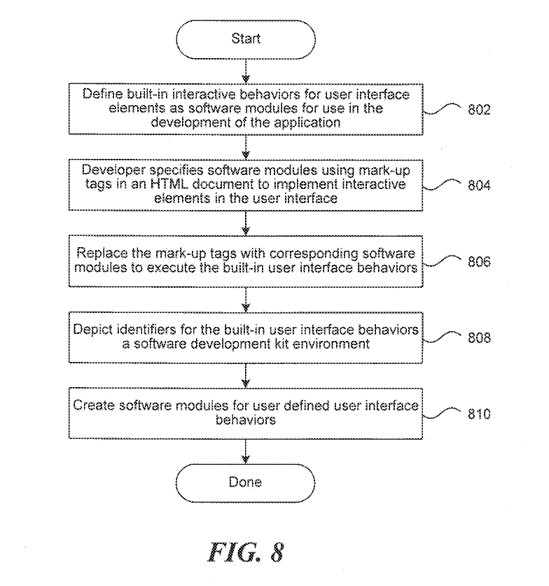

FIG. 8 depicts a flowchart of an example process for enabling development of a user interface without reliance on JavaScript.

In process 802, built-in interactive behaviors are defined for user interface elements as software modules for use in the development of the application. The interactive behaviors can include, for example, alert or confirmation messages, form validators (e.g., client side), right-click context menus (customizable), sortable tables, tabbed interface elements, tool tips, date selector, or other input form elements.

In process 804, a developer or user specifies software modules using mark-up tags in an HTML document to implement interactive elements in the user interface. Through declarative HTML, the developer need not rely on JavaScript to implement interactive UI features.

In process 806, the mark-up tags are replaced with corresponding software modules to execute the built-in user interface behaviors. In process 808, identifiers are depicted for the built-in user interface behaviors a software development kit environment. In addition, CSS files can be provisioned for the application. In addition, user interface behaviors can be user-definable. In process 810, software modules for user defined user interface behaviors are created. In one embodiment, the SDK is suited for development of applications to interact with a Hadoop-enabled clustered computing environment.

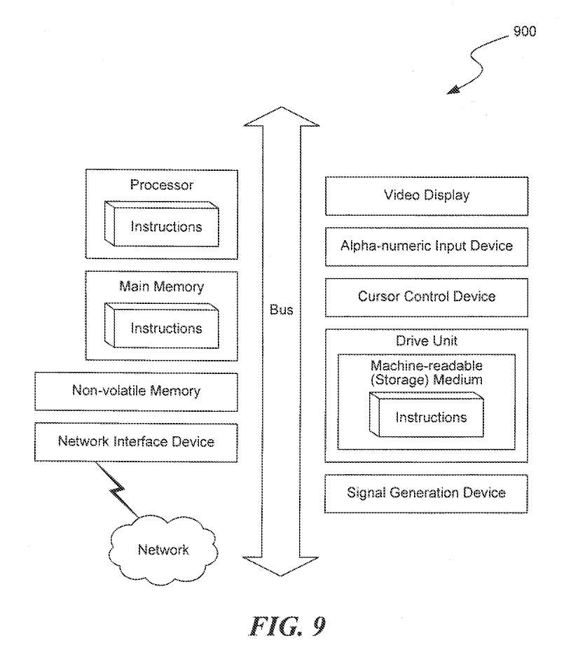

FIG. 9 shows a diagrammatic representation of a machine in the example form of a computer system within which a set of instructions, for causing the machine to perform any one or more of the methodologies discussed herein, may be executed.

In the example of FIG. 9, the computer system 900 includes a processor, memory, non-volatile memory, and an interface device. Various common components (e.g., cache memory) are omitted for illustrative simplicity. The computer system 900 is intended to illustrate a hardware device on which any of the components depicted in the example of FIG. 1 (and any other components described in this specification) can be implemented. The computer system 900 can be of any applicable known or convenient type. The components of the computer system 900 can be coupled together via a bus or through some other known or convenient device.

The processor may be, for example, a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory is coupled to the processor by, for example, a bus. The memory can include, by way of example but not limitation, random access memory (RAM), such as dynamic RAM (DRAM) and static RAM (SRAM). The memory can be local, remote, or distributed.

The bus also couples the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer 900. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

The bus also couples the processor to the network interface device. The interface can include one or more of a modem or network interface. It will be appreciated that a modem or network interface can be considered to be part of the computer system 1900. The interface can include an analog modem, isdn modem, cable modem, token ring interface, satellite transmission interface (e.g. “direct PC”), or other interfaces for coupling a computer system to other computer systems. The interface can include one or more input and/or output devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device. For simplicity, it is assumed that controllers of any devices not depicted in the example of FIG. 9 reside in the interface.

In operation, the computer system 1900 can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may thus be implemented using a variety of programming languages.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

in general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated, in general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, ¶6, other aspects may likewise be embodied as a means-plus-function claim, or in other forms, such as being embodied in a computer-readable medium, (Any claims intended to be treated under 35 U.S.C. §112, ¶6 will begin with the words “means for”.) Accordingly, the applicant reserves the right to add additional claims after filing the application to pursue such additional claim forms for other aspects of the disclosure.

What is claimed is:

1. A method of implementing interactive elements in a web page on a client device, the method, comprising:
sending, by the client device, a request to a web server in response to an event triggered in a specific frame of the web page having multiple frames;
processing a web server response from the web server for the specific frame;
unloading contents of the specific frame, after receipt of the web server response, when in accordance with rules defined for the web server response;
wherein, the contents are unloaded independent, of the other frames in the web page.

2. The method of claim 1, further comprising, rendering results of the web server response in the frame of the web page in which the event was triggered, independent of the other frames.

3. The method of claim 1, wherein, each of the multiple frames of the web page includes different applications which handle corresponding requests to the web server independent of the other applications loaded in other frames in the web page.

4. The method of claim 1, wherein, the contents of the frame include interactive web page features that are defined using HTML mark-ups.

5. The method of claim 1, wherein, the contents of the frame include interactive web page features that are defined without using JavaScript.

6. The method of claim 1, wherein, the web server response is processed in accordance with rules defined for the web server response.

7. The method of claim 1, the rules include, one or more of, an alert response, a confirm response, and a default response.

8. The method of claim 7, wherein, the rules are customizable.

9. The method of claim 1, further comprising, loading the frame with new content, independent of the other frames in the web browser based on the web server response.

10. The method of claim 1, wherein, the request includes an XML HTTP Request (XHR).

11. The method of claim 1, wherein, the event includes a form click, a link selection, or a custom call.

12. The method of claim 1, further comprising, performing custom actions when the event is a link selection; wherein, the link is loaded in the frame in which it was selected, independent of the other frames.

13. The method of claim 12, wherein, the custom action is defined by a developer as a re-usable module.

14. The method of claim 1, wherein, each of the multiple frames maintains its own state independent of the other frames.

15. The method of claim 1, wherein, each of the multiple frames performs its own load and unload operations, independent of the other frames.

16. The method of claim 1, wherein, shared resource among any of the multiple frames can be loaded once.

17. The method of claim 1, wherein, the web page interacts with a distributed file system.

18. The method of claim 17, wherein, the distributed file system is the Hadoop distributed file system.

19. A method to enable development of a user interface for an application executed on a client device, the method, comprising:
defining built-in interactive behaviors for user interface elements as software modules for use in the development of the application;
wherein, the software modules are specified using mark-up tags in an HTML document to implement interactive elements in the user interface, without reliance on JavaScript.

20. The method of claim 19, wherein, the application is used to interact with a Hadoop-enabled clustered computing environment.

21. The method of claim 19, wherein, the built-in interactive behaviors are executed by replacing the mark-up tags with corresponding software modules.

22. The method of claim 19, further comprising, depicting identifiers for the built-in user interface behaviors in a software development kit environment.

23. The method of claim 19, further comprising, provisioning a CSS file for the application.

24. The method of claim 19, wherein, user interface behaviors are user definable.

25. The method of claim 19, wherein, the interactive behaviors include, alert or confirmation messages.

26. The method of claim 19, wherein, the interactive behaviors include, client side form validation.

27. The method of claim 19, wherein, the interactive behaviors include, customizable right-click context menus.

28. The method of claim 19, wherein, the interactive behaviors include, sortable tables.

29. The method of claim 19, wherein, the interactive behaviors include, tabbed interface elements.

30. The method of claim 19, wherein, the interactive behaviors include, tool tips.

31. The method of claim 19, wherein, the interactive behaviors include, a date selector for an input form.

32. A system of implementing interactive elements in an application, the system, comprising:
means for, sending, by a client device, a request to a server in response to an event triggered in a frame of a windowing environment having multiple frames;
wherein, each of the multiple frames renders different applications which handle corresponding requests to the server independent of the other frames in the windowing environment;
means for, processing a response from the server for the frame;
means for, rendering results of the response in the frame of the windowing environment in which the event was triggered.

33. The system of claim 32, wherein, the request is an HTTP request.

34. The system of claim 32, further comprising, means for, unloading contents of the frame, after receipt of the response, independent of the other frames in the windowing environment.

35. The system of claim 32, wherein, the frame is able to share resources with another from of the same windowing environment.

36. The system of claim 34, wherein, the application on the client device includes a file browser to access a Hadoop clustered computing environment.

37. The system of claim 34, wherein, the application on the client device includes a resource manager for a clustered computing environment.

38. The system of claim 34, wherein, the application on the client device is used to access analytics or log data for a clustered computing environment.

39. A computer-readable storage medium having stored thereon instructions which when executed by a processor causes a method to be performed, the method, comprising:
sending a request to a web server in response to an event triggered in a frame of the web page having multiple frames;
processing a web server response from the web server for the frame;
rendering, in accordance with rules defined for the web server response, results of the web server response in the frame of the web page in which the event was triggered, independent of the other frames;
unloading contents of the frame, independent of the other frames in the web page.

40. The method of claim 39, wherein, the frame allows navigation independent of the other frames in the web page.

41. The method of claim 40, wherein, the navigation includes going forward or going backwards in the frame.
